(19) United States
(12) Patent Application Publication
(10) Pub. No.: US 2025/0356330 A1
(43) Pub. Date: Nov. 20, 2025

(54) METHOD AND SYSTEM OF SIMPLIFIED SETTLEMENT BETWEEN ISSUERS USING BLOCKCHAIN TECHNOLOGY

(71) Applicant: Mastercard International Incorporated, Purchase, NY (US)

(72) Inventors: Prathemesh Bhagwan BAGUL, Ratnagiri (IN); Uday Kiran GHADIYARAM, Siddartha Nagar (IN); Vaibhav KADGE, Mumbai (IN)

(73) Assignee: Mastercard International Incorporated, Purchase, NY (US)

(21) Appl. No.: 18/666,736

(22) Filed: May 16, 2024

(51) Int. Cl. G06Q 20/10; G06Q 20/14; G06Q 20/38

(52) U.S. Cl. CPC G06Q 20/102; G06Q 20/14; G06Q 20/381

(57) ABSTRACT

A method for performing simplified net settlement among entities facilitated by blockchain includes: receiving a plurality of settlement transactions including an amount, payer, payee, where each payer and payee are one of a plurality of entities; processing the settlement transactions to determine an amount owed or an amount due for each of the plurality of entities; determining a minimum amount of transactions for settlement among the plurality of entities based on the determined amounts owed or due; generating a list of net settlement transactions of the determined minimum amount, each net settlement transaction including an amount, payer, and payee based on the determined amounts owed or due for each entity; and transmitting the generated list of net settlement transactions to a blockchain node in a blockchain network for inclusion in a new blockchain data entry added to a blockchain associated with the blockchain network.

### FIELD

The present disclosure relates to the simplification of settlement between issuers through the use of blockchain, specifically the determination of the minimum number of necessary transactions for settlement for a large group of entities and tracking thereof on a blockchain.

### BACKGROUND

Settlement is a process that frequently occurs between financial institutions to settle accounts after a period of payment transactions involving transaction accounts for each institution. For example, an issuing bank that issues transaction accounts to consumers can have hundreds of consumers make purchases at a merchant in a single day, to be received in a transaction account issued to the merchant by an acquiring bank. Rather than make transfers directly to the acquiring bank every time one of the hundreds of transactions occurs, the issuing bank will wait until the end of the business day or other regularly scheduled time and make a single payment based on the aggregate amount of transactions. This reduces the fees incurred for the involved parties as well as reduces the bandwidth on the payment network, providing benefit to everyone involved.

However, in modern financial systems there are thousands of financial institutions that operate as issuers that issue transaction accounts to make or receive payments every single day. As a result, many of these financial institutions perform hundreds of settlement transactions daily, if not more often, resulting in potentially millions of additional transactions occurring each day, adding significant strain to payment networks, imposing significant fees on the involved parties, and requiring detail, meticulous accounting for the financial institutions. Thus, there is a need for a technological solution that improves the settlement process for financial institutions to significantly reduce the number of settlement transactions that occur as well as reduce the processing necessary by financial institutions, which can enhance efficiency and result in significant savings in energy usage as well as the reduction of fees.

### SUMMARY

The present disclosure provides a description of systems and methods for performing simplified net settlement among entities facilitated by blockchain. A processing server collects settlement information for a large group of financial institutions or other entities involved in settlement, collectively referred to herein as “issuers,” directly from the issuers, from a payment network, or other suitable source. The processing server determines the amount owed by or amount due to each of the issuers in the group based on the settlement amounts, and then determines the minimum number of transactions required to ensure that each issuer pays the required amount or receives the acquired amount to satisfy the determined amount owed or due. The processing server generates a list of net settlement transactions for the appropriate amounts from issuers that owe to issuers that are due funds that comprises the minimum number of transactions. The list is then provided to a blockchain node in a blockchain network and published on a blockchain, informing every involved entity of the amount and payments they must make to satisfy the settlement process. The result is that the minimum number of settlement transactions occurs for a large group of issuers, vastly reducing the energy used to process settlement transactions and providing significant savings in fees, while still ensuring that every issuer receives or pays the appropriate amount. The combination of the processing server and blockchain to generate and distribute the list of net settlement transactions provides a quick and reliable means of distribution that cannot be manipulated and provides suitable transparency and recording for regulatory purposes, while encryption can be used to maintain privacy as necessary. Thus, the methods and systems discussed herein provide significant technological advantages over traditional settlement processes.

A method for performing simplified net settlement among entities facilitated by blockchain includes: receiving, by a receiver of a processing server, a plurality of settlement transactions, wherein each settlement transaction includes an amount, a payer entity, and a payee entity, and wherein each payer entity and payee entity for each settlement transaction is one of a plurality of entities; processing, by a processor of the processing server, the received plurality of settlement transactions to determine an amount owed or an amount due for each entity of the plurality of entities based on at least the amount, the payer entity, and the payee entity for each settlement transaction in the plurality of settlement transactions; determining, by the processor of the processing server, a minimum amount of transactions for settlement among the plurality of entities based on at least the amount owed or amount due for each entity of the plurality of entities; generating, by the processor of the processing server, a list of net settlement transactions based on the determined minimum amount of transactions, wherein a number of net settlement transactions in the list of net settlement transactions matches the determined minimum amount of transactions, and wherein each net settlement transaction includes an amount, payer entity, and payee entity based on the determined amount owed or amount due for each entity of the plurality of entities; and transmitting, by a transmitter of the processing server, at least the generated list of net settlement transactions to a blockchain node in a blockchain network for inclusion in a new blockchain data entry added to a blockchain associated with the blockchain network.

A system for performing simplified net settlement among entities facilitated by blockchain includes: a blockchain network; a blockchain node included in the blockchain network; a plurality of entities; and a processing server, the processing server including a receiver receiving a plurality of settlement transactions, wherein each settlement transaction includes an amount, a payer entity, and a payee entity, and wherein each payer entity and payee entity for each settlement transaction is one of the plurality of entities, a processor of the processing server processing the received plurality of settlement transactions to determine an amount owed or an amount due for each entity of the plurality of entities based on at least the amount, the payer entity, and the payee entity for each settlement transaction in the plurality of settlement transactions, determine a minimum amount of transactions for settlement among the plurality of entities based on at least the amount owed or amount due for each entity of the plurality of entities, and generate a list of net settlement transactions based on the determined minimum amount of transactions, wherein a number of net settlement transactions in the list of net settlement transactions matches the determined minimum amount of transactions, and wherein each net settlement transaction includes an amount, payer entity, and payee entity based on the determined amount owed or amount due for each entity of the plurality of entities, and a transmitter transmitting at least the generated list of net settlement transactions to the blockchain node in the blockchain network for inclusion in a new blockchain data entry added to a blockchain associated with the blockchain network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for net settlement among entities facilitated by blockchain in accordance with exemplary embodiments.

FIG. 2 is a block diagram illustrating the processing server in the system of FIG. 1 for facilitating net settlement among entities using blockchain in accordance with exemplary embodiments.

FIG. 3 is a flow diagram illustrating a process for performing simplified net settlement among entities facilitated by blockchain in the system of FIG. 1 in accordance with exemplary embodiments.

FIG. 4 is a flow chart illustrating an exemplary method for performing simplified net settlement among entities facilitated by blockchain in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Simplified Net Settlement Using Blockchain

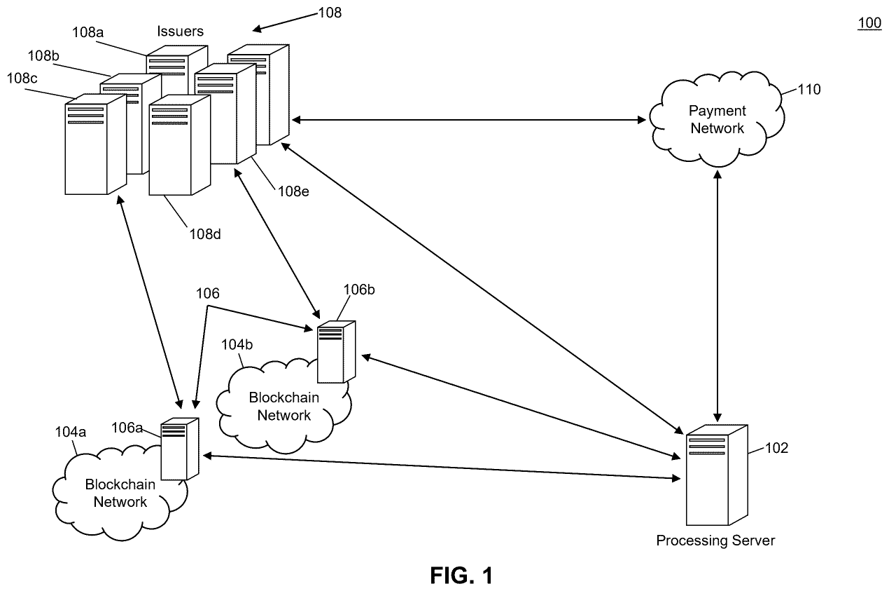

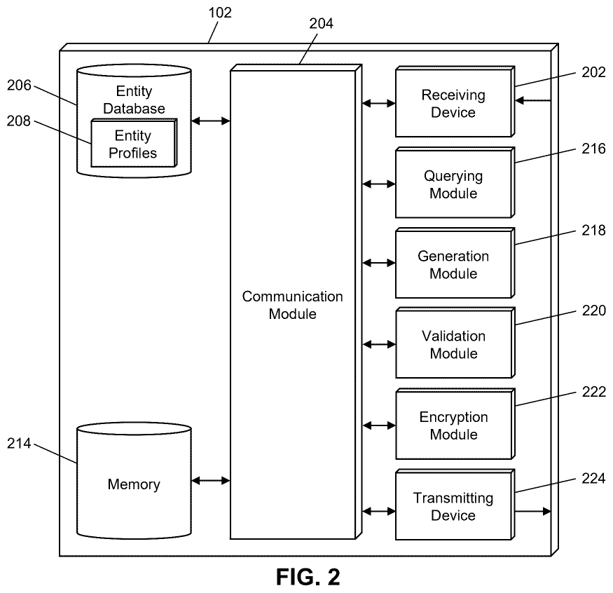

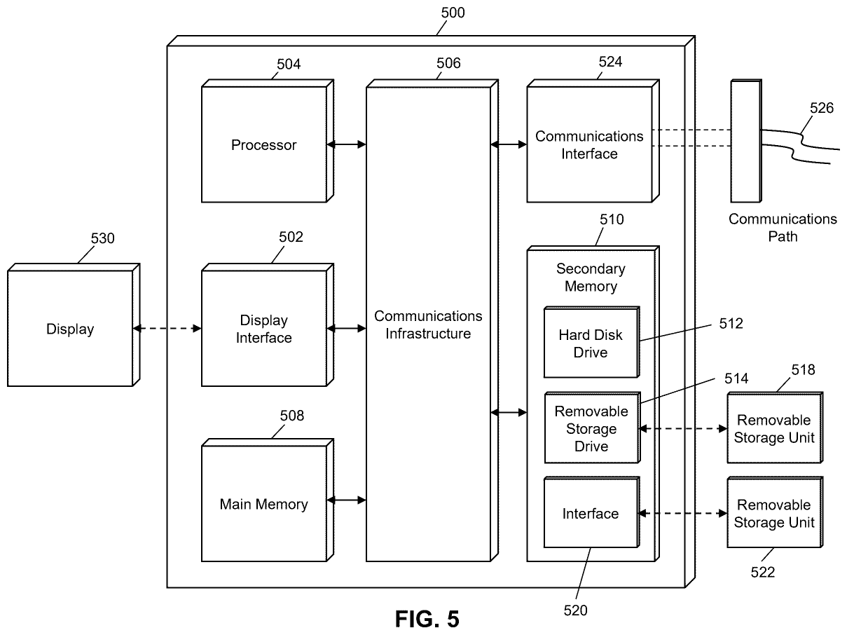

FIG. 1 illustrates a system 100 for a simplified net settlement process among entities through the use of a centralized processor and blockchain. The system 100 includes a processing server 102. The processing server 102, discussed in more detail below, may be a computing system, such as illustrated in FIG. 2 or 5, discussed in more detail below, that is specially configured to generate a list of net settlement transactions that is a minimum number of transactions required to satisfy settlement for a large group of entities. The list of net settlement transactions may be provided to a blockchain network 104a or 104b for storage on a blockchain. The blockchain networks 104a and 104b may be comprised of a plurality of blockchain nodes 106. Each blockchain node 106 can be a computing system, such as illustrated in FIG. 2 or 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in a blockchain network 104a or 104b prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 104a or 104b using the public key of the cryptographic key pair. In some cases, the term “blockchain wallet” can refer specifically to the private key. In other cases, the term “blockchain wallet” can refer to a computing device (e.g., participant system) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of that is generated using the sender's private key, a blockchain address of the recipient of currency generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in a blockchain network 104a or 104b, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104a or 104b before being added to the blockchain and distributed to all of the blockchain nodes 106 in the blockchain network 104a or 104b, respectively, in traditional blockchain implementations. In cases where a blockchain data value cannot be related to a blockchain transaction, but instead the storage of other types of data, blockchain data values can still include or otherwise involve the validation of a digital signature.

In the system 100, a blockchain can be used to store lists of net settlement transactions required to satisfy settlement for a plurality of issuers 108. As discussed herein, an “issuer” can refer to any entity that establishes (e.g., opens) a letter or line of credit in favor of a beneficiary, and honors drafts drawn by the beneficiary against the amount specified in the letter or line of credit. In many instances, the issuer can be a bank or other financial institution authorized to open lines of credit. In some instances, any entity that can extend a line of credit to a beneficiary can be considered an issuer. The line of credit opened by the issuer can be represented in the form of a payment account and can be drawn on by the beneficiary via the use of a payment card. An issuer can also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc. Any entity that participates in a payment transaction and can be involved in settlement with another entity is referred to herein as an issuer 108.

As used herein, “payment transaction” can refer to a transaction between two entities in which money or other financial benefit is exchanged from one entity to the other. The payment transaction can be a transfer of funds, for the purchase of goods or services, for the repayment of debt, or for any other exchange of financial benefit as will be apparent to persons having skill in the relevant art. In some instances, “payment transaction” can refer to transactions funded via a payment card and/or payment account, such as credit card transactions. Such payment transactions can be processed via an issuer 108, payment network 110, and acquirer. The process for processing such a payment transaction can include at least one of authorization, batching, clearing, settlement, and funding. Authorization can include the furnishing of payment details by the consumer to a merchant, the submitting of transaction details (e.g., including the payment details) from the merchant to their acquirer, and the verification of payment details with the issuer of the consumer's payment account used to fund the transaction. Batching can refer to the storing of an authorized transaction in a batch with other authorized transactions for distribution to an acquirer. Clearing can include the sending of batched transactions from the acquirer to a payment network 110 for processing. Settlement can include the debiting of the issuer by the payment network for transactions involving beneficiaries of the issuer. In some instances, the issuer can pay the acquirer via the payment network. In other instances, the issuer can pay the acquirer directly. Funding can include payment to the merchant from the acquirer for the payment transactions that have been cleared and settled. As used herein, net settlement transactions can refer to the transactions that facilitate the funding discussed above, as a result of the settlement process.

The system 100 includes a payment network 110. The payment network 110 is a system or network used for the transfer of money via the use of cash-substitutes for thousands, millions, and even billions of transactions during a given period. Payment networks may use a variety of different protocols and procedures in order to process the transfer of money for various types of transactions. Transactions that can be performed via a payment network may include product or service purchases, credit purchases, debit transactions, fund transfers, account withdrawals, etc. Payment networks may be configured to perform transactions via cash-substitutes, which can include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein can refer to both the payment network as an entity, and the physical payment network, such as the equipment, hardware, and software comprising the payment network, also known to persons having skill in the art as “payment rails.”

In the system 100, a large group of issuers can all participate in payment transactions processed by the payment network 110 as payers, payees, or a combination thereof through issued transaction accounts. Each issuer 108 may participate in the system 100 to take advantage of minimized settlement transactions, and thereby associated processing costs and fees, through the use of the processing server 102. The processing server 102 may begin the simplified net settlement process by obtaining a list of all traditional settlement transactions required by each of the issuers 108 for settlement. In one embodiment, each issuer 108 may electronically transmit a list of all settlement transactions to the processing server 102 using a suitable communication network and method, such as via an application programming interface (API) connected to the processing server 102. In another embodiment, the payment network 110 may provide a list of traditional settlement transactions to the processing server 102 for all issuers 108 that have provided authorization for use in the processes discussed herein. In some instances, the issuers 108 and/or payment network 110 may provide a list of all transactions involving an issuer 108, where the processing server 102 may be configured to identify the settlement transactions required by the respective issuer 108. For instance, the processing server 102 may evaluate the amounts, payers, and payees for each of the transactions involving the issuer 108 to determine the amounts owed to or due from each other issuer 108 in the group of issuers.

In an example, the group of issuers can include five different issuers, issuers 108A, 108B, 108C, 108D, and 108E. It will be apparent to persons having skill in the relevant art that the group of issuers can number in the hundreds or thousands to provide even more significant reduction in settlement transactions, but an example using five issuers is provided for convenience and ease of explanation. In the example, the processing server 102 can receive the following settlement transactions from the issuers in the group:

1) Issuer 108A owes $8,000 to issuer 108B.

2) Issuer 108A owes $5,000 to issuer 108C.

3) Issuer 108B owes $4,000 to issuer 108C.

4) Issuer 108C owes $2,000 to issuer 108D.

5) Issuer 108D owes $3,000 to issuer 108A.

6) Issuer 108D owes $7,000 to issuer 108B.

7) Issuer 108D owes $3,000 to issuer 108E.

8) Issuer 108E owes $6,000 to issuer 108A.

9) Issuer 108E owes $2,000 to issuer 108B.

As noted above, the processing server 102 can receive the settlement transactions from each issuer 108 directly (e.g., issuer 108A can provide to the processing server that they owe $8,000 to issuer 108B and $5,000 to issuer 108C while being owed $3,000 from issuer 108D and $6,000 from issuer 108E), or can receive a list of all transactions involving each of the issuers 108A, 108B, 108C, 108D, and 108E and can aggregate the amounts owed to and from each issuer to arrive at the above list of nine settlement transactions.

To facilitate a simplified net settlement, the processing server 102 can first process the settlement transactions to determine the amount owed by or amount due to each of the issuers in the group. In the above example, the processing server 102 can determine that issuer 108A owes $4,000, issuer 108B is due $13,000, issuer 108C is due $7,000, issuer 108D owes $11,000, and issuer 108E owes $5,000. The processing server 102 may then determine the minimum number of transactions required in order to ensure that every issuer in the group is adequately settled using a suitable algorithm. In the above example, the minimum number of transactions is four. The processing server 102 may then generate a list of net settlement transactions of the minimum number that satisfies settlement for all of the involved issuers. In the above example, the processing server 102 can generate the following list of net settlement transactions:

1) Issuer 108A owes $2,000 to issuer 108B.

2) Issuer 108A owes $2,000 to issuer 108C.

3) Issuer 108D owes $11,000 to issuer 108B.

4) Issuer 108E owes $5,000 to issuer 108C.

In the above example, the number of settlement transactions is reduced by over 55%. In cases where the group of issuers is larger or the number of settlement transactions is larger, the reduction can be even greater. In instances where thousands of traditional settlement transactions occur regularly each day, the resulting decrease in processing and network bandwidth can have significant ecological and economic impact.

Once the list of net settlement transactions is generated by the processing server 102, the processing server 102 may electronically transmit the list to a blockchain node 106a in a first blockchain network 104a. The blockchain node 106a may receive the list of net settlement transactions and add the list of net settlement transactions into new blockchain data entry that is included in a new block and added to the blockchain using traditional methods and systems. Each of the issuers 108 in the group may identify their required net settlement transactions from the list and then initiate the appropriate settlement transactions accordingly using traditional methods and systems. In the above example, only issuers 108A, 108D, and 108E would be required to initiate settlement transactions, completely eliminating the need for 40% of the issuers in the group to initiate new transactions and incur any fees for settlement.

By having the list of net settlement transactions added to the blockchain, the ability for any of the issuers to manipulate settlement can be significantly reduced due to the immutable nature of the blockchain. In addition, the blockchain provides an immutable record of settlement over the life of the blockchain, which can aid in regulatory compliance. In cases where the issuers prefer that settlement amounts and/or entity identities are not public, the blockchain can be a permissioned blockchain such that only the authorized issuers in the group can access the blockchain data. In some cases, the processing server 102 may encrypt the list of net settlement transactions prior to transmission to the blockchain node 106. In such cases, the processing server 102 can encrypt each net settlement transaction using a public key of a key pair where the payer issuer 108 has the corresponding private key, such that only the payer issuer 108 can decrypt the net settlement transaction, preventing any other issuer 108 from identifying the payers and payment amounts for the other settlement transactions. In some such cases, the list of net settlement transactions can also include payee issuers 108 and amounts owed to that are encrypted only for decryption by the payee issuer 108.

In some embodiments, a second blockchain may be used to store aggregated settlement values, such as to provide additional convenience to involved issuers, further transparency for accuracy, a suitable data record for regulatory compliance, etc. In such embodiments, the processing server 102 may generate a list of settlement amounts for each issuer 108 in the group. In the above example, the list of settlement amounts for issuer 108A can be as follows:

1) Owes $8,000 to issuer 108B.

2) Owes $5,000 to issuer 108C.

3) Is due $3,000 from issuer 108D.

4) Is due $6,000 from issuer 108E.

The processing server 102 can electronically transmit the list of settlement amounts for each issuer 108 to a blockchain node 106 for addition to the second blockchain. In some cases, the second blockchain can be operated by the same blockchain network 104 that operates the blockchain of net settlement transactions, referred to herein as the “first blockchain.” In other cases, the second blockchain can be operated by a different blockchain network. In the example system 100 illustrated in FIG. 1, the first blockchain network 104a can operate the first blockchain while a second blockchain network 104b can operate the second blockchain. In some cases, one or more of the blockchain nodes 106a in the first blockchain network 104a can also operate as blockchain nodes in the second blockchain network 104b.

In cases where a single second blockchain is used to store the list of settlement amounts for each issuer 108 in the group, the list of settlement amounts can be encrypted in a manner only suitable for decryption by the associated issuer 108, such as using the processing discussed above. In other cases, a separate second blockchain can be maintained for each issuer 108 in the group, where each of the second blockchains can be permissioned blockchains such that only the appropriate issuer 108 can access the blockchain data. In such cases, the blockchain data stored therein can be unencrypted due to the restrictions on access. In some embodiments, the lists of settlement amounts can be stored in other suitable data storage. For instance, the processing server 102 can store a profile for each issuer 108 where the list of settlement amounts can be stored therein. In another example, each issuer 108 can independently store each list of settlement amounts generated by the processing server 102 and provided thereto via a suitable communication network and method.

In some embodiments, one or more of the issuers 108 in the group can be geographically located in another country or can use a currency that is different from currency used by other issuers 108 in the group. In such embodiments, the processing server 102 can perform currency conversion as part of the simplified net settlement process. In an example, most of the issuers 108 in the group can utilize the United States Dollar (USD), while one of the issuers 108 in the group can utilize the Mexican Peso (MXP). In such an example, the processing server 102 can convert all currencies for settlement transactions into a single currency (e.g., USD) and generate the list of net settlement transactions, and then convert the amount for any net settlement transactions with the issuer 108 that uses MXP into MXP using the exchange rate between USD and MXP. The result is that all issuers 108 can participate in the system 100 regardless of currency used.

The methods and systems discussed herein provide for a simplified net settlement process among issuers 108 participating in a payment network 110 that provides a significant ecological and economic advantage over traditional settlement methods. By aggregating settlement amounts for a larger group of issuers, the number of net settlement transactions required to ensure that every issuer is adequately settled can be drastically reduced. The drastic reduction in transactions can provide a significant decrease in the number of transactions processed, which vastly reduces the power utilized by payment networks 110 in the processing of settlement transactions, providing significant ecological benefits, while also reducing the fees incurred by the issuers 108, providing economic benefits thereto. By using a central processing server to determine the simplified net settlement transactions, the number of communications necessary in the settlement process can be drastically reduced as each issuer 108 only needs to communicate with the processing server 102 rather than every other issuer 108 involved in settlement. In addition, the use of a blockchain to distribute and store the net settlement transactions simplifies the distribution process and requires less communications for all involved entities, while providing security to all involved entities by drastically reducing the ability for an issuer 108 to commit fraud and by providing a secure and reliable storage for regulatory compliance.

### Processing Server

FIG. 2 illustrates an embodiment of a processing server 102. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102.

The processing server 102 includes a receiving device 202. The receiving device 202 is configured to receive data over one or more networks via one or more network protocols. In some instances, the receiving device 202 is configured to receive data from processing servers 102, blockchain nodes 106, issuers 108, payment networks 110, and other systems and entities via one or more communication methods, such as radio frequency, local area networks, wireless area networks, cellular communication networks, Bluetooth, the Internet, etc. In some embodiments, the receiving device 202 is comprised of multiple devices, such as different receiving devices for receiving data over different networks, such as a first receiving device for receiving data over a local area network and a second receiving device for receiving data via the Internet. The receiving device 202 receives electronically transmitted data signals, where data can be superimposed or otherwise encoded on the data signal and decoded, parsed, read, or otherwise obtained via receipt of the data signal by the receiving device 202. In some instances, the receiving device 202 includes a parsing module for parsing the received data signal to obtain the data superimposed thereon. For example, the receiving device 202 includes a parser program configured to receive and transform the received data signal into usable input for the functions performed by the processing device to carry out the methods and systems described herein.

The receiving device 202 is configured to receive data signals electronically transmitted by blockchain nodes 106 that are superimposed or otherwise encoded with blockchain data, blockchain data entries, blocks, block requests, confirmation messages, etc. The receiving device 202 may also be configured to receive data signals electronically transmitted by issuers 108 and/or payment networks 110, which can be superimposed or otherwise encoded with transaction messages, settlement amounts, settlement transactions, public keys of cryptographic key pairs, currency types, etc.

The processing server 102 also includes a communication module 204. The communication module 204 is configured to transmit data between modules, engines, databases, memories, and other components of the processing server 102 for use in performing the functions discussed herein. The communication module 204 is comprised of one or more communication types and utilize various communication methods for communications within a computing device. For example, the communication module 204 may be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 also includes a processing device. The processing device is configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 216, generation module 218, validation module 220, encryption module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 also includes an entity database 206. The entity database 206 is configured to store one or more entity profiles 208 using a suitable data storage format and schema. The entity database 206 may be a relational database that utilizes structured query language for the storage, identification, modifying, updating, accessing, etc. of structured data sets stored therein. Each entity profile 208 may be a structured data set configured to store data related to an entity, such as an issuer 108. For example, an entity profile 208 may include received payment transaction data, received settlement transactions, determined settlement amounts, determined net settlement transactions, public keys of cryptographic key pairs, currency types, etc.

The processing server 102 also includes a memory 214. The memory 214 is configured to store data for use by the processing server 102 in performing the functions discussed herein, such as public and private keys, symmetric keys, etc. The memory 214 is configured to store data using suitable data formatting methods and schema and can be any suitable type of memory, such as read-only memory, random access memory, etc. The memory 214 may include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 may be comprised of or may otherwise include a relational database that utilizes structured query language for the storage, identification, modifying, updating, accessing, etc. of structured data sets stored therein. The memory 214 is configured to store, for example, device profiles, device profile data, configuration keys, cryptographic keys including public keys and/or private keys, communication data, blockchain algorithms and data, currency exchange rates, settlement algorithms, etc.

The processing server 102 includes a querying module 216. The querying module 216 is configured to execute queries on databases to identify information. The querying module 216 may receive one or more data values or query strings and can execute a query string based thereon on an indicated database, such as the entity database 206 of the processing server 102 to identify information stored therein. The querying module 216 may then output the identified information to an appropriate engine or module of the processing server 102 as necessary. The querying module 216 may, for example, execute a query on the entity database 206 to identify a public key of a cryptographic key pair where the related issuer 108 has the corresponding private key for use in encrypting settlement amounts or net settlement transactions.

The processing server 102 also includes a generation module 218. The generation module 218 is configured to generate data for use by the processing server 102 in performing the functions discussed herein. The generation module 218 may receive instructions as input, can generate data based on the instructions, and may output the generated data to one or more modules of the processing server 102. For example, the generation module 218 may be configured to generate settlement amounts, determine minimum numbers of settlement transactions, generate lists of net settlement transactions, generate lists of settlement amounts, generate converted currency amounts, etc.

The processing server 102 also includes a validation module 220. The validation module 220 is configured to perform data validations and verifications for the processing server 102 as part of the functions discussed herein. The validation module 220 may receive instructions as input, may perform data validations or verification as instructed, and may output a result of the data validations or verifications to one or more modules of the processing server 102. In some cases, the input may include the data to be validated or verified and/or data to be used in the validation or verification. In other cases, the validation module 220 may be configured to identify such data, such as in the entity database 206 and/or memory 214. The validation module 220 may be configured to, for example, validate settlement amounts, verify that net settlement transactions satisfy settlement amounts, verify processed settlement transactions, etc.

The processing server 102 also includes an encryption module 222. The encryption module 222 is be configured to encrypt and/or decrypt data for the processing server 102 as part of the functions discussed herein. The encryption module 222 may receive instructions as input, may encrypt or decrypt data as instructed, and may output a result of the encryption or decryption to one or more modules of the processing server 102. In some cases, the input may include the data to be encrypted or decrypted and/or keys for use in the encryption or decryption. In other cases, the encryption module 222 may be configured to identify such data, such as in the memory 214. The encryption module 222 may be configured to encrypt device settlement amounts, encrypt net settlement transactions, encrypt or decrypt transaction data, etc.

The processing server 102 also includes a transmitting device 224. The transmitting device 224 is configured to transmit data over one or more networks via one or more network protocols. In some instances, the transmitting device 224 may be configured to transmit data to blockchain nodes 106, issuers 108, payment networks 110, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that can be parsed by a receiving computing device. In some instances, the transmitting device 224 may include one or more modules for superimposing, encoding, or otherwise formatting data into data signals suitable for transmission.

The transmitting device 224 is also configured to electronically transmit data signals to blockchain nodes 106 that can be superimposed or otherwise encoded with blockchain data entries, blocks, confirmation messages, lists of settlement amounts, lists of net settlement transactions, etc. The transmitting device 224 may also be configured to electronically transmit data signals to issuers 108 and/or payment networks 110, which can be superimposed or otherwise encoded with requests for transaction data, requests for cryptographic keys, encrypted data, lists of settlement amounts, required net settlement transaction notifications, etc.

### Process for Simplified Net Settlement

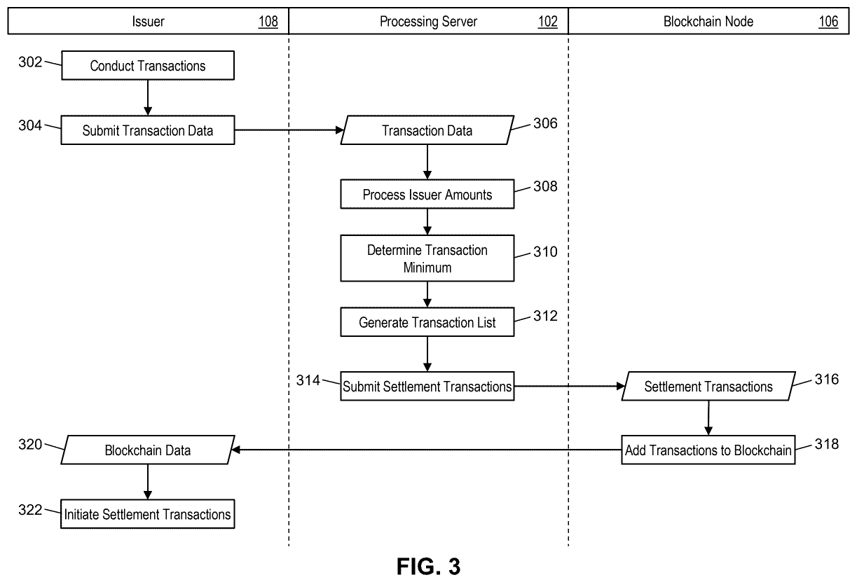

FIG. 3 illustrates a process in the system 100 of FIG. 1 for simplified net settlement for a group of issuers using blockchain. While the process illustrated in FIG. 3 includes a single issuer 108 for convenience and ease of explanation, the functions performed by the issuer 108 as discussed herein can be performed by each issuer 108 of a large group of issuers in as part of the simplified net settlement processes discussed herein.

In step 302, an issuer 108 in the large group of issuers can participate in a plurality of payment transactions processed by a payment network 110 during a predetermined period of time (e.g., daily). Each of the payment transactions may involve the issuer 108 as (e.g., via an issued transaction account) a payer or payee of the payment transaction for a specified transaction amount. The issuer 108 may aggregate the amounts paid to and due from each other issuer in the large group of issuers and, in step 304, may electronically transmit transaction data to the processing server 102 using a suitable communication network and method. The transaction data may include the aggregated amounts paid to and due from each other issuer in the payment transactions involving the issuer 108 during the predetermined period of time. In step 306, the receiving device 202 of the processing server 102 may receive the transaction data from the issuer 108 as well as other issuers in the large group of issuers.

In step 308, the generation module 218 of the processing server 102 may process the received transaction data to generate a list of settlement amounts for the issuer 108 and every other issuer in the large group of issuers. Each list of settlement amounts may include the amounts owed to and due from each other issuer in the large group of issuers. In the example provided in the system 100 of FIG. 1, the list of settlement amounts for the issuer 108A may include $8,000 owed to issuer 108B, $5,000 owed to issuer 108C, $3,000 due from issuer 108D, and $6,000 due from issuer 108E. The generation module 218 of the processing server 102 may further determine the net settlement amount for the issuer 108 and each other issuer in the large group of issuers. In the example provided in the system 100 of FIG. 1, the net settlement amount for the issuer 108A may be $4,000 owed by the issuer 108A. In step 310, the generation module 218 of the processing server 102 determines the minimum number of net settlement transactions required in order to satisfy settlement for the issuer 108 and each other issuer in the large group of issuers. In the example provided in the system 100 of FIG. 1, the minimum number of net settlement transactions can be determined to be four.

In step 312, the generation module 218 of the processing server 102 may generate the list of net settlement transactions, which may include the minimum number of net settlement transactions, and where each net settlement transaction in the list includes an amount, payer issuer, and payee issuer, such that, once all of the net settlement transactions have been completed, each of the issuers in the large group of issuers will be adequately settled according to the generated net settlement amounts for each issuer. In the example provided in the system 100 of FIG. 1, the generation module 218 of the processing server 102 may generate the list of four net settlement transactions, which may include two payments of $2,000 by the issuer 108A, a first payment to the issuer 108B and a second payment to the issuer 108C. In embodiments where data stored on the blockchain is encrypted, the encryption module 222 of the processing server 102 may encrypt each net settlement transaction in the list using a public key associated with the payer issuer involved in the respective transaction (e.g., identified in the entity profile 208 of the entity database 206 that is related to the payer issuer). In step 314, the transmitting device 224 of the processing server 102 may electronically transmit the list of net settlement transactions to a blockchain node 106 in the blockchain network 104a or 104b using a suitable communication network and method.

In step 316, the blockchain node 106 may receive the list of net settlement transactions. In step 318, the blockchain node 106 may include the list of net settlement transactions (e.g., as encrypted, if necessary) in a new blockchain data entry that is generated and added to a new block that is then transmitted to other blockchain nodes 106 in the blockchain network 104 for confirmation using traditional methods and systems. Once confirmed, the new block that includes the list of net settlement transactions may be added to the blockchain. In step 320, the issuer 108 may receive the list of net settlement transactions in the new blockchain data entry. The issuer 108 may identify the net settlement transactions for which they are the payer entity (e.g., after decryption using their private key, if necessary) and, in step 322, may initiate payment transactions for the appropriate payment amount to the appropriate payee issuer as indicated in the net settlement transactions. The result may be that a minimum number of transactions are processed in order to satisfy settlement for a large group of issuers, providing significant advantages to all involved entities through an efficient and secure process via use of the processing server 102 and blockchain.

### Exemplary Method for Performing Simplified Net Settlement

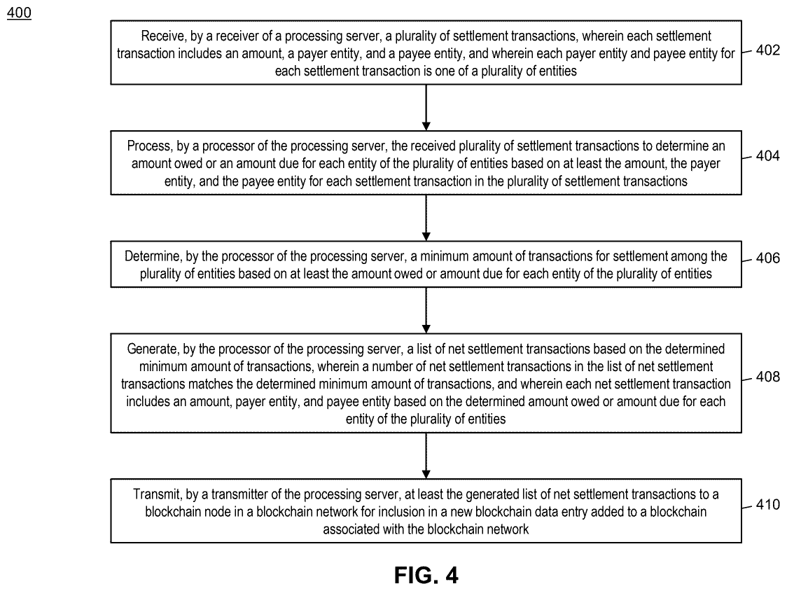

FIG. 4 illustrates a method 400 for the performing of a simplified net settlement process among entities facilitated via the use of a blockchain.

In step 402, a plurality of settlement transactions may be received by a receiver (e.g., receiving device 202) of a processing server (e.g., processing server 102), wherein each settlement transaction can include an amount, a payer entity (e.g., issuer 108), and a payee entity (e.g., issuer 108), and wherein each payer entity and payee entity for each settlement transaction is one of a plurality of entities (e.g., issuers 108). In step 404, a processor (e.g., generation module 218) of the processing server may process the received plurality of settlement transactions to determine an amount owed or an amount due for each entity of the plurality of entities based on at least the amount, the payer entity, and the payee entity for each settlement transaction in the plurality of settlement transactions. In step 406, the processor (e.g., generation module 218) of the processing server may determine a minimum amount of transactions for settlement among the plurality of entities based on at least the amount owed or amount due for each entity of the plurality of entities.

In step 408, the processor (e.g., generation module 218) of the processing server may generate a list of net settlement transactions based on the determined minimum amount of transactions, wherein a number of net settlement transactions in the list of net settlement transactions matches the determined minimum amount of transactions, and wherein each net settlement transaction includes an amount, payer entity, and payee entity based on the determined amount owed or amount due for each entity of the plurality of entities. In step 410, at least the generated list of net settlement transactions may be transmitted by a transmitter (e.g., transmitting device 224) of the processing server to a blockchain node (e.g., blockchain node 106a or 106b) in a blockchain network (e.g., blockchain network 104a or 104b) for inclusion in a new blockchain data entry added to a blockchain associated with the blockchain network.

In one embodiment, the method 400 may further include transmitting, by the transmitter of the processing server, each net settlement transaction of the list of net settlement transactions to the respective payer entity for initiation of a payment transaction for payment of the amount included in the respective net settlement transaction to the respective payee entity. In some embodiments, each settlement transaction of the plurality of settlement transactions can further include one of a plurality of currency types, and the determined amount owed or an amount due for each entity of the plurality of entities can be represented in one of the plurality of currency types and can be further based on a converted amount for each settlement transaction in the plurality of settlement transactions based on a conversion of the amount for the respective settlement transaction converted into the one of the plurality of currency types. In one embodiment, the plurality of entities can include at least five entities.

In some embodiments, the method 400 may also include generating, by the processor of the processing server, a list of individual settlements for each entity of the plurality of entities, wherein the list of individual settlements includes each settlement transaction of the plurality of settlement transactions that involves the respective entity of the plurality of entities as the payer entity or the payee entity. In a further embodiment, the method 400 may even further include transmitting, by the transmitter of the processing server, the generated list of individual settlements to a second blockchain node (e.g., blockchain node 106b) in a second blockchain network (e.g., blockchain network 104b) for inclusion in a new data entry added to a permissioned blockchain associated with the second blockchain network. In another further embodiment, the method 400 may further include determining, by the processor of the processing server, a list of settlement amounts for each entity of the plurality of entities based on the generated list of individual settlements for the respective entity, wherein the list of settlement amounts includes an amount owed to or amount due from each other entity in the plurality of entities. In a yet further embodiment, the method 400 may even further include transmitting, by the transmitter of the processing server, the generated list of settlement amounts to a second blockchain node in a second blockchain network for inclusion in a new data entry added to a permissioned blockchain associated with the second blockchain network.

### Computer System Architecture

FIG. 5 illustrates a computer system 500 in which embodiments of the present disclosure, or portions thereof, can be implemented as computer-readable code. For example, the processing server 102, blockchain nodes 106, and issuers 108 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general-purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc. The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for performing simplified net settlement among entities facilitated by blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

1. A method for performing simplified net settlement among entities facilitated by blockchain, comprising:
receiving, by a receiver of a processing server, a plurality of settlement transactions from at least a multitude of issuers, wherein each settlement transaction includes an amount, a payer entity, and a payee entity, and wherein each payer entity and payee entity for each settlement transaction is one of a plurality of entities, wherein said processing server is centrally located within a payment system;
determining an amount owed or an amount due for each entity of the plurality of entities by processing, by a processor of the processing server, the received plurality of settlement transactions, wherein said determination is based on at least the amount, the payer entity, and the payee entity for each settlement transaction in the plurality of settlement transactions;
determining, by the processor of the processing server, a minimum amount of transactions for settlement among the plurality of entities based on at least the amount owed or amount due for each entity of the plurality of entities;
generating, by the processor of the processing server, a list of net settlement transactions based on the determined minimum amount of transactions, wherein a number of net settlement transactions in the list of net settlement transactions matches the determined minimum amount of transactions, and wherein each net settlement transaction includes an amount, payer entity, and payee entity based on the determined amount owed or amount due for each entity of the plurality of entities;
encrypting, by the processor of the processing server, the list of net settlement transactions using a public key of a key pair where the payer entity has a corresponding private key such that only the payer entity is permitted to decrypt a respective net settlement transaction, thereby preventing any other payer entity from identifying payers and payment amounts for other settlement transactions; and
transmitting, by a transmitter of the processing server, at least the generated list of net settlement transactions to a blockchain node in a blockchain network where said generated list of settlement transaction is included in a new blockchain data entry added to a blockchain associated with the blockchain network.

2. The method of claim 1, further comprising:
transmitting, by the transmitter of the processing server, each net settlement transaction of the list of net settlement transactions to the respective payer entity where a payment transaction is initiated for payment of the amount included in the respective net settlement transaction to the respective payee entity.

3. The method of claim 1, further comprising:
generating, by the processor of the processing server, a list of individual settlements for each entity of the plurality of entities, wherein the list of individual settlements includes each settlement transaction of the plurality of settlement transactions that involves the respective entity of the plurality of entities.

4. The method of claim 3, further comprising:
transmitting, by the transmitter of the processing server, the generated list of individual settlements to a second blockchain node in a second blockchain network where the generated list of individual settlements is included in a new data entry added to a permissioned blockchain associated with the second blockchain network.

5. The method of claim 3, further comprising:
determining, by the processor of the processing server, a list of settlement amounts for each entity of the plurality of entities based on the generated list of individual settlements for the respective entity, wherein the list of settlement amounts includes an amount owed to or amount due from each other entity in the plurality of entities.

6. The method of claim 5, further comprising:
transmitting, by the transmitter of the processing server, the generated list of settlement amounts to a second blockchain node in a second blockchain network where said generated list of settlement amounts is included in a new data entry added to a permissioned blockchain associated with the second blockchain network.

7. The method of claim 1, wherein
each settlement transaction of the plurality of settlement transactions further includes one of a plurality of currency types, and
the determined amount owed or an amount due for each entity of the plurality of entities is represented in one of the plurality of currency types and is further based on a converted amount for each settlement transaction in the plurality of settlement transactions based on a conversion of the amount for the respective settlement transaction converted into the one of the plurality of currency types.

8. The method of claim 1, wherein the plurality of entities includes at least five entities.

9. A system for performing simplified net settlement among entities facilitated by blockchain, comprising:
a blockchain network;
a blockchain node included in the blockchain network;
a plurality of entities; and
a processing server centrally located within the system, the processing server including
a receiver receiving a plurality of settlement transactions from at least a multitude of issuers, wherein each settlement transaction includes an amount, a payer entity, and a payee entity, and wherein each payer entity and payee entity for each settlement transaction is one of the plurality of entities,
a processor of the processing server
processing the received plurality of settlement transactions to determine an amount owed or an amount due for each entity of the plurality of entities based on at least the amount, the payer entity, and the payee entity for each settlement transaction in the plurality of settlement transactions,
determine a minimum amount of transactions for settlement among the plurality of entities based on at least the amount owed or amount due for each entity of the plurality of entities,
generate a list of net settlement transactions based on the determined minimum amount of transactions, wherein a number of net settlement transactions in the list of net settlement transactions matches the determined minimum amount of transactions, and wherein each net settlement transaction includes an amount, payer entity, and payee entity based on the determined amount owed or amount due for each entity of the plurality of entities,
encrypt the list of net settlement transactions using a public key of a key pair where the payer entity has a corresponding private key such that only the payer entity is permitted to decrypt a respective net settlement transaction, thereby preventing any other payer entity from identifying payers and payment amounts for other settlement transactions, and
a transmitter transmitting at least the encrypted generated list of net settlement transactions to the blockchain node in the blockchain network for inclusion in a new blockchain data entry added to a blockchain associated with the blockchain network.

10. The system of claim 9, wherein the transmitter of the processing server transmits each net settlement transaction of the list of net settlement transactions to the respective payer entity for initiation of a payment transaction for payment of the amount included in the respective net settlement transaction to the respective payee entity.

11. The system of claim 9, wherein the processor of the processing server generates a list of individual settlements for each entity of the plurality of entities, wherein the list of individual settlements includes each settlement transaction of the plurality of settlement transactions that involves the respective entity of the plurality of entities.

12. The system of claim 11, further comprising:
a second blockchain network; and
a second blockchain node included in the second blockchain network, wherein
the transmitter of the processing server transmits the generated list of individual settlements to the second blockchain node in the second blockchain network for inclusion in a new data entry added to a permissioned blockchain associated with the second blockchain network.

13. The system of claim 11, wherein the processor of the processing server determines a list of settlement amounts for each entity of the plurality of entities based on the generated list of individual settlements for the respective entity, wherein the list of settlement amounts includes an amount owed to or amount due from each other entity in the plurality of entities.

14. The system of claim 13, further comprising:
a second blockchain network; and
a second blockchain node included in the second blockchain network, wherein
the transmitter of the processing server transmits the generated list of settlement amounts to the second blockchain node in the second blockchain network for inclusion in a new data entry added to a permissioned blockchain associated with the second blockchain network.

15. The system of claim 9, wherein
each settlement transaction of the plurality of settlement transactions further includes one of a plurality of currency types, and
the determined amount owed or an amount due for each entity of the plurality of entities is represented in one of the plurality of currency types and is further based on a converted amount for each settlement transaction in the plurality of settlement transactions based on a conversion of the amount for the respective settlement transaction converted into the one of the plurality of currency types.

16. The system of claim 9, wherein the plurality of entities includes at least five entities.
